(19) United States
(12) Patent Application Publication
(10) Pub. No.: US 2016/0340254 A1
(43) Pub. Date: Nov. 24, 2016

(54) CEMENT COMPOSITIONS, STRUCTURES, AND METHODS OF USE

(71) Applicant: LUXE CRETE LLC, St. George, UT (US)

(72) Inventors: Alfred Lee Edgar, St. George, UT (US); Delbert Omar Turley, St. George, UT (US); Alfred Lloyd Edgar, St. George, UT (US)

(73) Assignee: LUXE CRETE, LLC, St. George, UT (US)

(21) Appl. No.: 15/111,941

(22) PCT Filed: Jan. 16, 2015
(86) PCT No.: PCT/US15/11867

§ 371 Date: Jul. 15, 2016

Related U.S. Application Data
(60) Provisional application No. 61/979,452, filed on Apr. 14, 2014.
(60) Provisional application No. 61/928,945, filed on Jan. 17, 2014.

(51) Int. Cl. C04B 28/32; E04B 5/32; E04F 15/08; C04B 24/42

(52) U.S. Cl. CPC C04B 28/32; C04B 24/42; E04B 5/32; E04F 15/08; C04B 2111/27

(57) ABSTRACT

A magnesium oxychloride cement composition can include magnesium oxide, aqueous magnesium chloride, and one or more silicone based additives. The magnesium oxychloride cement composition can exhibit water resistant characteristics. The disclosed magnesium oxychloride cement compositions can be used to form various structures, including countertops, flooring structures, tile structures, panel structures, and other cement and/or concrete structures. The structures can also include a support member and/or a cushioned underlay.

### CROSS-REFERENCE TO RELATED APPLICATIONS

This patent application claims priority to U.S. Provisional Patent Application No. 61/928,945 entitled CEMENT COMPOSITIONS, STRUCTURES, AND METHODS OF USE, filed on Jan. 17, 2014, and U.S. Provisional Patent Application No. 61/979,452 entitled CEMENT COMPOSITIONS, STRUCTURES, AND METHODS OF USE, filed on Apr. 14, 2014, each of which is incorporated herein by reference in its entirety.

### TECHNICAL FIELD

The present disclosure relates generally to cement compositions, structures, and methods of use. More specifically, the present disclosure relates to magnesium oxychloride cement compositions that include one or more silicone based additives. The magnesium oxychloride cement compositions can be used to manufacture various structures, including but not limited to, countertops, flooring structures, tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, and other cement or concrete structures.

### BRIEF DESCRIPTION OF THE DRAWINGS

The written disclosure describes illustrative embodiments that are non-limiting and non-exhaustive. Reference is made to certain of such illustrative embodiments depicted in the figures, in which:

FIG. 1 is a perspective view of an embodiment of a countertop;

FIG. 2 is a cross-sectional view of the countertop of FIG. 1;

FIG. 3 is another perspective view of the countertop of FIG. 1;

FIG. 4 is a cross-sectional view of another embodiment of a countertop;

FIG. 5 is a cross-sectional view of an embodiment of a flooring structure;

FIG. 6 is a cross-sectional view of another embodiment of a flooring structure; and

FIG. 7 is a cross-sectional view of another embodiment of a flooring structure.

### DETAILED DESCRIPTION

Magnesium oxychloride cement compositions are advantageous in many ways. For example, magnesium oxychloride cement compositions have excellent workability. Magnesium oxychloride cement compositions possess high bonding characteristics and quick setting properties. Magnesium oxychloride cement compositions also produce high strength cement and concrete structures. Other advantages of magnesium oxychloride cement compositions include their anti-bacterial, anti-fungal, and anti-microbial properties.

However, traditional magnesium oxychloride cement compositions also have certain disadvantages. For example, traditional magnesium oxychloride cement compositions are sensitive to water. Indeed, traditional magnesium oxychloride cement compositions can lose strength, degrade, crack, and/or break after being exposed to water. As a result, the use of traditional magnesium oxychloride cement compositions has been limited.

The present disclosure relates to magnesium oxychloride cement compositions comprising one or more silicone based additives that aid in alleviating and/or overcoming various disadvantages associated with traditional magnesium oxychloride cement compositions. Also disclosed herein are structures made using the disclosed magnesium oxychloride cement compositions, and methods of using the disclosed magnesium oxychloride cement compositions. These and other embodiments are discussed in detail below.

In some embodiments, the magnesium oxychloride cement compositions disclosed herein comprise magnesium oxide (MgO), aqueous magnesium chloride (MgCl₂ (aq)), and one or more silicone based additives. Various silicone based additives can be used, including, but not limited to, silicone oils, neutral cure silicones, silanols, silanol fluids, and mixtures and derivatives thereof. Silicone oils include liquid polymerized siloxanes with organic side chains, including, but not limited to, polymethylsiloxane and derivatives thereof. Neutral cure silicones include silicones that release alcohol or other volatile organic compounds (VOCs) as they cure. Other silicone based additives and/or siloxanes (e.g., siloxane polymers) can also be used, including, but not limited to, hydroxyl (or hydroxy) terminated siloxanes and/or siloxanes terminated with other reactive groups, acrylic siloxanes, urethane siloxanes, epoxy siloxanes, and mixtures and derivatives thereof. As detailed below, one or more crosslinkers (e.g., silicone based crosslinkers) can also be used.

In some embodiments, the viscosity of the one or more silicone based additives (e.g., silicone oil, neutral cure silicone, silanol fluid, siloxane polymers, etc.) is about 100 cSt (25° C.). Other viscosities can also be used. For example, in some embodiments, the viscosity of the one or more silicone based additives (e.g., silicone oil, neutral cure silicone, silanol fluid, siloxane polymers, etc.) is between about 20 cSt (25° C.) and about 2000 cSt (25° C.). In other embodiments, the viscosity of the one or more silicone based additives (e.g., silicone oil, neutral cure silicone, silanol fluid, siloxane polymers, etc.) is between about 100 cSt (25° C.) and about 1250 cSt (25° C.). In other embodiments, the viscosity of the one or more silicone based additives (e.g., silicone oil, neutral cure silicone, silanol fluid, siloxane polymers, etc.) is between about 250 cSt (25° C.) and 1000 cSt (25° C.). In yet other embodiments, the viscosity of the one or more silicone based additives (e.g., silicone oil, neutral cure silicone, silanol fluid, siloxane polymers, etc.) is between about 400 cSt (25° C.) and 800 cSt (25° C.). And in particular embodiments, the viscosity of the one or more silicone based additives (e.g., silicone oil, neutral cure silicone, silanol fluid, siloxane polymers, etc.) is between about 800 cSt (25° C.) and about 1250 cSt (25° C.).

One or more silicone based additives having higher and/or lower viscosities can also be used. For example, in further embodiments, the viscosity of the one or more silicone based additives (e.g., silicone oil, neutral cure silicone, silanol fluid, siloxane polymers, etc.) is between about 20 cSt (25° C.) and about 200,000 (25° C.) cSt, between about 1,000 cSt (25° C.) and about 100,000 cSt (25° C.), or between about 80,000 cSt (25° C.) and about 150,000 cSt (25° C.). In other embodiments, the viscosity of the one or more silicone based additives (e.g., silicone oil, neutral cure silicone, silanol fluid, siloxane polymers, etc.) is between about 1,000 cSt (25° C.) and about 20,000 cSt (25° C.), between about 1,000 cSt (25° C.) and about 10,000 cSt (25° C.), between about 1,000 cSt (25° C.) and about 2,000 cSt (25° C.), or between about 10,000 cSt (25° C.) and about 20,000 cSt (25° C.). In yet other embodiments, the viscosity of the one or more silicone based additives (e.g., silicone oil, neutral cure silicone, silanol fluid, siloxane polymers, etc.) is between about 1,000 cSt (25° C.) and about 80,000 cSt (25° C.), between about 50,000 cSt (25° C.) and about 100,000 cSt (25° C.), or between about 80,000 cSt (25° C.) and about 200,000 cSt (25° C.). And in still further embodiments, the viscosity of the one or more silicone based additives (e.g., silicone oil, neutral cure silicone, silanol fluid, siloxane polymers, etc.) is between about 20 cSt (25° C.) and about 100 cSt (25° C.). Other viscosities can also be used as desired.

In certain embodiments, the magnesium oxychloride cement composition comprises a single type of silicone based additive. In other embodiments, a mixture of two or more types of silicone based additives are used. For example, in some embodiments, the magnesium oxychloride cement composition can include a mixture of one or more silicone oils and neutral cure silicones. In particular embodiments, the ratio of silicone oil to neutral cure silicone can be between about 1:5 and about 5:1, by weight. In other such embodiments, the ratio of silicone oil to neutral cure silicone can be between about 1:4 and about 4:1, by weight. In other such embodiments, the ratio of silicone oil to neutral cure silicone can be between about 1:3 and about 3:1, by weight. In yet other such embodiments, the ratio of silicone oil to neutral cure silicone can be between about 1:2 and about 2:1, by weight. In further such embodiments, the ratio of silicone oil to neutral cure silicone can be about 1:1, by weight.

One or more crosslinkers can also be used. In some embodiments, the crosslinkers are silicone based crosslinkers. Exemplary crosslinkers include, but are not limited to, methyltrimeihoxysilane, methyltrielhoxysilane, methyltris(methylethylketoximino)silane and mixtures and derivatives thereof. Other crosslinkers (including other silicone based crosslinkers) can also be used. In some embodiments, the magnesium oxychloride cement composition comprises one or more silicone based additives (e.g., one or more silanols and/or silanol fluids) and one or more crosslinkers. The ratio of one or more silicone based additives (e.g., silanols and/or silanol fluids) to crosslinker can be between about 1:20 and about 20:1, by weight, between about 1:10 and about 10:1 by weight, or between about 1:1 and about 10:1, by weight.

The magnesium oxychloride cement compositions comprising one or more silicone based additives may exhibit reduced sensitivity to water as compared to traditional magnesium oxychloride cement compositions. Further, in some embodiments, the magnesium oxychloride cement compositions comprising one or more silicone based additives may exhibit little or no sensitivity to water. The magnesium oxychloride cement compositions comprising one or more silicone based additives can further exhibit hydrophobic and water resistant properties.

The magnesium oxychloride cement compositions comprising one or more silicone based additives can also exhibit improved curing characteristics. For example, magnesium oxychloride cement compositions cure to form various reaction products, including 3Mg(OH)₂.MgCl₂.8H₂O (phase 3) and 5Mg(OH)₂.MgCl₂.8H₂O (phase 5) crystalline structures. In some situations, higher percentages of the 5Mg(OH)₂.MgCl₂.8H₂O (phase 5) crystalline structure is preferred. In such situations, the addition of one or more silicone based additives to the magnesium oxychloride cement compositions can stabilize the curing process which can increase the percentage yield of 5Mg(OH)₂.MgCl₂.8H₂O (phase 5) crystalline structures. For example, in some embodiments, the magnesium oxychloride compositions comprising one or more silicone based additives can cure to form greater than 80% 5Mg(OH)₂.MgCl₂.8H₂O (phase 5) crystalline structures. In other embodiments, the magnesium oxychloride compositions comprising one or more silicone based additives can cure to form greater than 85% 5Mg(OH)₂.MgCl₂.8H₂O (phase 5) crystalline structures. In yet other embodiments, the magnesium oxychloride compositions comprising one or more silicone based additives can cure to form greater than 90% 5Mg(OH)₂.MgCl₂.8H₂O (phase 5) crystalline structures. In yet other embodiments, the magnesium oxychloride compositions comprising one or more silicone based additives can cure to form greater than 95% 5Mg(OH)₂.MgCl₂.8H₂O (phase 5) crystalline structures. In yet other embodiments, the magnesium oxychloride compositions comprising one or more silicone based additives can cure to form greater than 98% 5Mg(OH)₂.MgCl₂.8H₂O (phase 5) crystalline structures. In yet other embodiments, the magnesium oxychloride compositions comprising one or more silicone based additives can cure to form about 100% 5Mg(OH)₂.MgCl₂.8H₂O (phase 5) crystalline structures.

The magnesium oxychloride cement compositions comprising one or more silicone based additives can also exhibit increased strength and bonding characteristics. If desired, the magnesium oxychloride cement compositions comprising one or more silicone based additives can also be used to manufacture magnesium oxychloride cement or concrete structures that are relatively thin. For example, the magnesium oxychloride cement compositions comprising one or more silicone based additives can be used to manufacture cement or concrete structures or layers having thicknesses of less than 2 inches, less than 1 inch, or less than ½ inch. In particular embodiments, the magnesium oxychloride cement compositions comprising one or more silicone based additives can be used to form countertops wherein the thickness of the cement or concrete layer is about, or no greater than about, ¼ inch. In other embodiments, the magnesium oxychloride cement compositions comprising one or more silicone based additives can be used to form structures (e.g., tiles structures (e.g., floor tiles, roof tiles, etc.), panel structures (floor panels, shower panels, wall panels, etc.) wherein the thickness of the cement or concrete layer is about, or no greater than about, 3/16 inch. In still other particular embodiments, the magnesium oxychloride cement compositions comprising one or more silicone based additives can be used to form flooring structures wherein the thickness of the cement or concrete layer is about, or no greater than about, ⅜ inch. These and other relatively thin cement or concrete structures have significant economic advantages (e.g., less raw material is required), construction advantages (e.g., less weight), and aesthetic advantages. Historically, relatively thin magnesium oxychloride cement or concrete structures were not commercially viable due to a lack of strength and high susceptibility to cracking or breaking.

The magnesium oxychloride cement compositions comprising one or more silicone based additives can also exhibit a degree of flexibility and/or elasticity. For example, in some embodiments, cement and concrete structures formed using the magnesium oxychloride cement compositions can bend or flex without cracking or breaking. For example, in some illustrative embodiments, a 6′ long×12″ wide×¼″ thick structure formed using the disclosed magnesium oxychloride cement compositions can bend at least 5″-6″ at its midsection before cracking or breaking. The flexibility and/or elasticity can also be reversible. For example, after flexing or bending, the cement and concrete structures can be biased towards returning to their initial pre-bent or pre-flexed conformation. The flexibility or elasticity of the magnesium oxychloride cement compositions can also enable the manufacture of flooring structures and surfaces that comprise a cushioned underlay. Historically, cement and/or concrete flooring structures have been too rigid for use with a cushioned underlay.

In certain embodiments, the magnesium oxychloride cement compositions comprising one or more silicone based additives do not require the use of additional aggregates. In such embodiments, the addition of one or more silicone based additives to the magnesium oxychloride cement compositions increases the bonding of the cement composition such that the reinforcement by aggregates is not required. In contrast, aggregates have historically been necessary with many magnesium oxychloride cement compositions to provide the strength and support necessary to keep the cement structures from crumbling, breaking, or otherwise falling apart.

As can be appreciated, however, the disclosed magnesium oxychloride cement compositions comprising one or more silicone based additives are not limited to compositions that are devoid of aggregates. Rather, in some embodiments, the magnesium oxychloride cement compositions comprising one or more silicone based additives can further comprise one or more aggregates if desired. Exemplary aggregates include, but are not limited to, sand, gravel, crushed stone, crushed glass, and recycled concrete. Other known aggregates can also be used.

The magnesium oxychloride cement compositions comprising one or more silicone based additives can further comprise one or more additional additives. The additional additives can be used to enhance particular characteristics of the composition. For example, in some embodiments, the additional additives can be used to make the structures formed using the disclosed magnesium oxychloride cement compositions look like stone (e.g., granite, marble, sandstone, etc.). In particular embodiments, the additional additives can include one or more pigments or colorants. In other embodiments, the additional additives can include fibers, including, but not limited to, paper fibers, polymeric fibers, organic fibers, and fiberglass. The magnesium oxychloride cement compositions can also form structures that are UV stable, such that the color and/or appearance is not subject to substantial fading from UV light over time. Other additives can also be included in the composition, including, but not limited to plasticizers (e.g., polycarboxylic acid plasticizers, polycarboxylate ether-based plasticizers, etc.), surfactants, water, and mixtures and combinations thereof.

As previously mentioned, the magnesium oxychloride cement compositions disclosed herein can comprise magnesium oxide (MgO), aqueous magnesium chloride (MgCl₂ (aq)), and one or more silicone based additives. As can be appreciated, the magnesium chloride (MgCl₂) need not be in aqueous form. Rather, magnesium chloride (MgCl₂) powder can also be used. For example, magnesium chloride (MgCl₂) powder can be used in combination with an amount of water that would be equivalent or otherwise analogous to the addition of aqueous magnesium chloride (MgCl₂ (aq)).

In certain embodiments, the ratio of magnesium oxide (MgO) to aqueous magnesium chloride (MgCl₂ (aq)) in the magnesium oxychloride cement composition can vary. In some of such embodiments, the ratio of magnesium oxide (MgO) to aqueous magnesium chloride (MgCl₂ (aq)) is between about 0.3:1 and about 1.2:1, by weight. In other embodiments, the ratio of magnesium oxide (MgO) to aqueous magnesium chloride (MgCl₂ (aq)) is between about 0.4:1 and about 1.2:1, by weight. And in yet other embodiments, the ratio of magnesium oxide (MgO) to aqueous magnesium chloride (MgCl₂ (aq)) is between about 0.5:1 and about 1.2:1, by weight.

In further embodiments, the ratio of magnesium oxide (MgO) to aqueous magnesium chloride (MgCl₂ (aq)) is between about 0.6:1 and about 1.1:1, by weight. In still further embodiments, the ratio of magnesium oxide (MgO) to aqueous magnesium chloride (MgCl₂ (aq)) is between about 0.7:1 and about 1:1, by weight. And in still further embodiments, the ratio of magnesium oxide (MgO) to aqueous magnesium chloride (MgCl₂ (aq)) is between about 0.3:1 and about 0.6:1, by weight. Other ratios of magnesium oxide (MgO) to aqueous magnesium chloride (MgCl₂ (aq)) can also be used.

In some embodiments, forming the magnesium oxychloride cement compositions comprises mixing a magnesium oxide (MgO) powder, an aqueous magnesium chloride (MgCl₂ (aq)) solution, and one or more silicone based additives. In some embodiments, the silicone based additives form an emulsion within the mixture. In certain embodiments, the silicone based additives can also form a microsuspension within the mixture (e.g., a microsuspension of polymer in liquid).

As can be appreciated, the aqueous magnesium chloride (MgCl₂ (aq)) can be described as (or otherwise derived from) a magnesium chloride brine solution. The aqueous magnesium chloride (MgCl₂ (aq)) (or magnesium chloride brine) can also include relatively small amounts of other compounds or substances, including but not limited to, magnesium sulfate, magnesium phosphate, hydrochloric acid, phosphoric acid, etc.

The specific gravity or concentration of the aqueous magnesium chloride (MgCl₂ (aq)) (or magnesium chloride brine) that is used can be described in degrees of Baume. In some embodiments, the specific gravity of the aqueous magnesium chloride (MgCl₂ (aq)) (or magnesium chloride brine) is between about 17° Baume and about 37° Baume. In other embodiments, the specific gravity of the aqueous magnesium chloride (MgCl₂ (aq)) (or magnesium chloride brine) is between about 20° Baume and about 34° Baume. In yet other embodiments, the specific gravity of the aqueous magnesium chloride (MgCl₂ (aq)) (or magnesium chloride brine) is between about 22° Baume and about 32° Baume. In still other embodiments, the specific gravity of the aqueous magnesium chloride (MgCl₂ (aq)) (or magnesium chloride brine) is between about 24° Baume and about 30° Baume. In still other embodiments, the specific gravity of the aqueous magnesium chloride (MgCl₂ (aq)) (or magnesium chloride brine) is between about 30° Baume and about 34° Baume. Other ranges of specific gravity of aqueous magnesium chloride (MgCl₂ (aq)) (or magnesium chloride brine) can also be used.

In some embodiments, silica such as fumed silica, silica fume, or micro silica can also be added to the magnesium oxychloride cement composition. For example, in certain embodiments, silica such as fumed silica, silica fume, or micro silica comprising a surface area of between about 50 m²/g to about 600 m²/g can be included in the compositions. In other embodiments, the silica such as fumed silica, silica fume, or micro silica comprises a surface area of between about 100 m²/g to about 500 m²/g. In yet other embodiments, the silica such as fumed silica, silica fume, or micro silica comprises a surface area of between about 150 m²/g to about 300 m²/g. And in yet other embodiments, the silica such as fumed silica, silica fume, or micro silica comprises a surface area of about 200 m²/g.

The amount of silica such as fumed silica, silica fume, or micro silica used can be defined as the ratio of silica (e.g., fumed silica, silica fume, or micro silica) to aqueous magnesium chloride (MgCl₂ (aq)) (or magnesium chloride brine). For example, in some embodiments, the ratio of silica (e.g., fumed silica, silica fume, or micro silica) to aqueous magnesium chloride (MgCl₂ (aq)) is between about 1 lb: 25 lbs and about 1 lb: 40 lbs. In yet other embodiments, the ratio of silica (e.g., fumed silica, silica fume, or micro silica) to aqueous magnesium chloride (MgCl₂ (aq)) is between about 1 lb: 30 lbs and about 1 lb: 35 lbs. In certain of such embodiments, the silicone based additive can bond to the silica (e.g., fumed silica, silica fume, or micro silica) resulting in a microsuspension of polymer in the oxychloride cement composition.

In the disclosed embodiments, the amount of the one or more silicone based additives within the magnesium oxychloride cement composition can be defined as the ratio of silicone based additives to magnesium oxide (MgO). For example, in some embodiments, the ratio of silicone based additives to magnesium oxide (MgO) is between about 1 fl oz:1 lb and about 10 fl oz:1 lb. In other embodiments, the ratio of silicone based additives to magnesium oxide (MgO) is between about 1 fl oz:1 lb and about 8 fl oz:1 lb. In yet other embodiments, the ratio of silicone based additives to magnesium oxide (MgO) is between about 1 fl oz:1 lb and about 5 fl oz:1 lb. And in still other embodiments, the ratio of silicone based additives to magnesium oxide (MgO) is between about 1 fl oz:1 lb and about 4 fl oz:1 lb.

In further embodiments, the ratio of silicone based additives to magnesium oxide (MgO) is between about 1.5 fl oz:1 lb and about 3.5 fl oz:1 lb. In still further embodiments, the ratio of silicone based additives to magnesium oxide (MgO) is between about 2 fl oz:1 lb and about 3 fl oz:1 lb. And in still further embodiments, the ratio of silicone based additives to magnesium oxide (MgO) is between about 2.2 fl oz:1 lb and about 2.8 fl oz:1 lb. Other ratios of silicone based additives to magnesium oxide (MgO) can also be used.

In certain embodiments, the magnesium oxychloride cement compositions comprising one or more silicone based additives can be used with particular grout compositions. Illustrative grout compositions include, but are not limited to, magnesium phosphate cement compositions. Other additives can be added to the magnesium phosphate cement compositions, including, but not limited to plasticizers (e.g., polycarboxylic acid plasticizers, polycarboxylate ether-based plasticizers, etc.), acrylic siloxanes, water, and mixtures thereof.

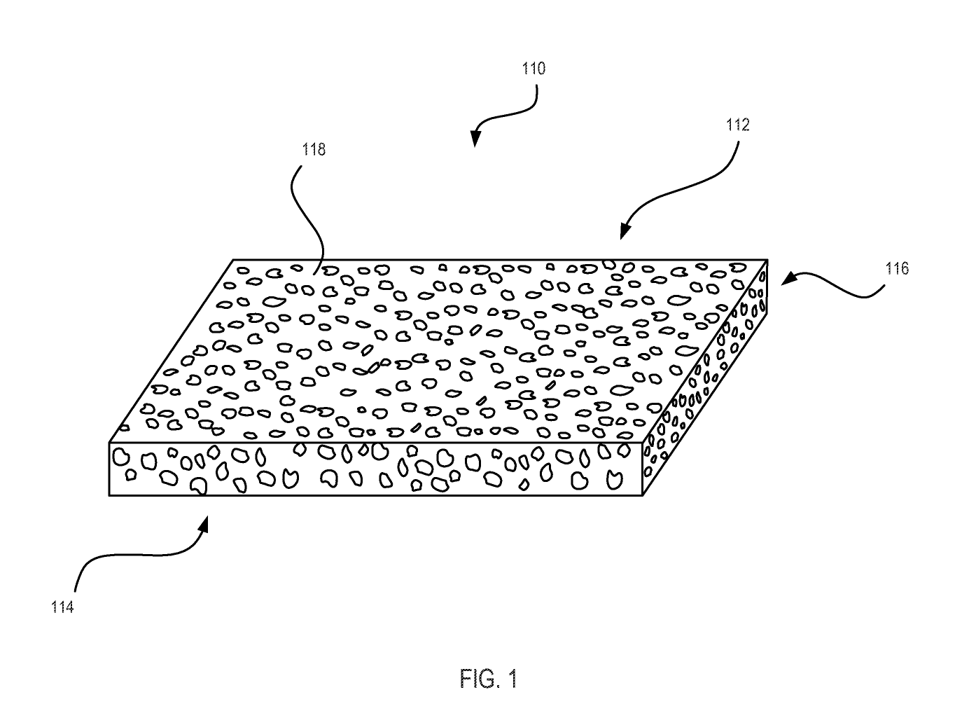

The disclosed magnesium oxychloride cement compositions comprising one or more silicone based additives can be used to manufacture various structures, including cement and concrete structures. For example, the magnesium oxychloride cement compositions comprising silicone based additives can be mixed with aggregates and other components to make concrete compositions or mixtures. Further, as shown in FIGS. 1-7, in some embodiments, the magnesium oxychloride cement compositions can be used to manufacture countertops and flooring structures. As can be appreciated, the magnesium oxychloride cement compositions can also be used to manufacture other structures, including, but not limited to, tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, and other cement or concrete structures.

It will be readily understood that the drawings are not intended to limit the scope of the disclosure and uses thereof, but are merely representative of possible embodiments of the disclosure. Additionally, it will be appreciated that the components of the drawings could be arranged and designed in a wide variety of different configurations. Further, in some cases, well-known structures, materials, or operations are not shown or described in detail. While various aspects of the embodiments are presented in the drawings, the drawings are not necessarily drawn to scale unless specifically indicated.

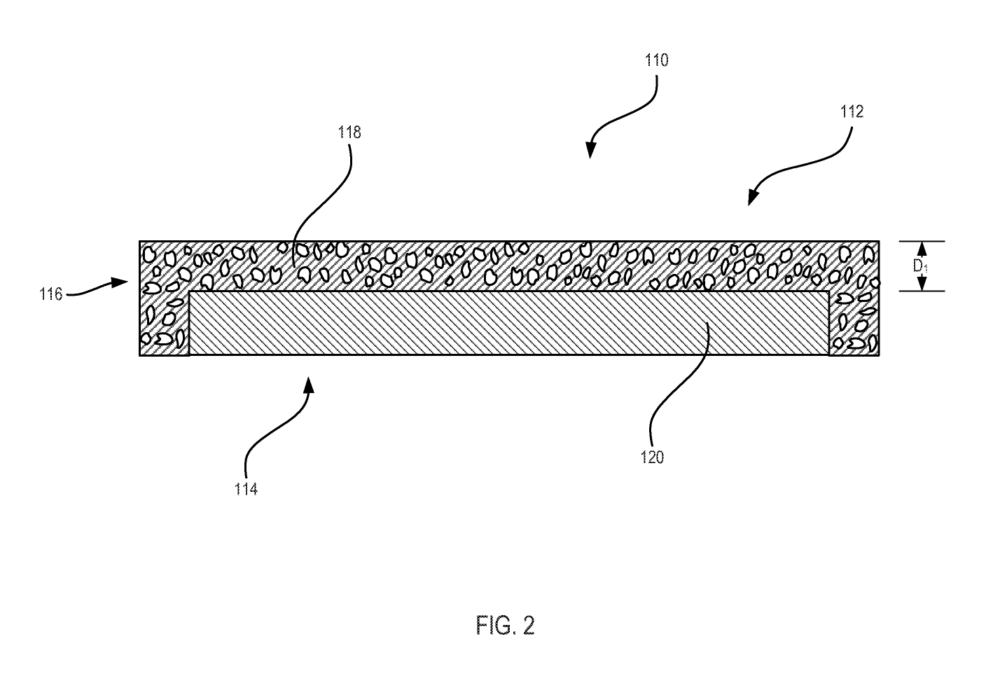

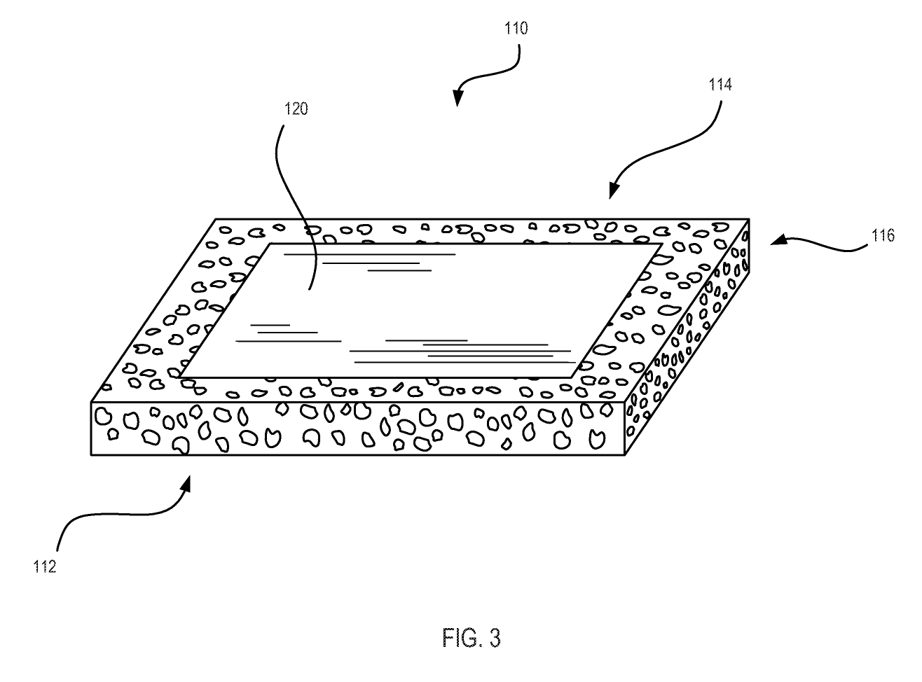

FIGS. 1-3 depict an embodiment of a countertop 110, according to the present disclosure. More specifically, FIG. 1 depicts a perspective view of the countertop 110 illustrating the top surface 112; FIG. 2 depicts a cross-sectional view of the countertop 110; and FIG. 3 depicts another perspective view of the countertop 110 illustrating the bottom surface 114. As can be appreciated, the structure 110 depicted in FIGS. 1-3 could also represent other cement or concrete structures, including, but not limited to, tile structures (e.g., floor tiles, roof tiles, etc.), panel structures (e.g., floor panels, shower panels, wall panels, etc.), and other building structures.

The shape and/or size of the countertop 110 can vary as desired. As shown in FIGS. 1-3, for example, the shape of the countertop 110 can be substantially rectangular. In other embodiments, the shape of the countertop 110 can be substantially circular, substantially square, or substantially triangular. Any other suitable shape can also be used. For example, the shape of the countertop 110 can be non-quadrilateral and/or irregular (i.e., not a traditionally defined shape). It will further be appreciated that the countertop 110 can be custom shaped for installation in a particular location. The countertop 110 can also be any suitable size.

With continued reference to FIGS. 1-3, the countertop 110 can comprise a first surface 112 (e.g., an upward facing surface), a second surface 114 (e.g., a downward facing surface), and a third surface 116 (e.g., a side surface). The first surface 112 can be substantially planar, or it can be sloped. The second surface 114 can be used to fasten the countertop 110 to a base structure. And the third surface 116 can extend around the periphery of the countertop 110, or around a portion of the periphery of the countertop 110.

The countertop 110 comprises a cement or concrete layer 118. The cement or concrete layer 118 comprises a magnesium oxychloride cement composition comprising one or more silicone based additives as disclosed herein. The thickness D₁ of the cement or concrete layer 118 of the countertop 110 can vary. In some embodiments, the thickness D₁ of the cement or concrete layer 118 of the countertop 110 can be less than 1 inch. In further embodiments, the thickness D₁ of the cement or concrete layer 118 of the countertop 110 can be less than ½ inch. And in still further embodiments, the thickness D₁ of the cement or concrete layer 118 of the countertop 110 can be about, or no greater than about, ¼ inch. Larger thicknesses can also be used if desired. For example, thicknesses D₁ of about ⅓ inch, about ½ inch, about ⅔ inch, and greater are also contemplated. As is further shown in FIG. 2, the thickness of the cement or concrete layer 118 can increase around the side edges of the countertop 110.

In certain embodiments, such as the embodiment of FIGS. 1-3, the countertop 110 further comprises a support member 120. The support member 120 can provide structural support to the cement or concrete layer 118 of the countertop 110. In some of such embodiments, the support member 120 can be embedded in the countertop 110. For example, in the depicted embodiment of FIGS. 1-3, the support member 120 is embedded in the second surface 114 or defines a portion of the second surface 114. In other embodiments, a support member 120 need not be used.

In some embodiments, the support member 120 can comprise a wood material. Illustrative wood materials that can be used include plywood, particle board, and oriented strand board (OSB). Other wood materials can also be used. In embodiments wherein the support member 120 comprises a wood material (or a liquid or water absorbing material), the support member 120 can be coated with a waterproofing substance prior to being contacted with the cement or concrete layer 118 comprising a magnesium oxychloride cement composition. The waterproofing substance can aid in keeping the wood material from absorbing substantial amounts of water from the magnesium oxychloride cement composition prior to curing.

Other types of support members 120 can also be used. For example, in some embodiments, the support member 120 can comprise a cement based material, including, but not limited to, cement boards, fiber cement boards, magnesium oxychloride cement based boards, etc. In still other embodiments, the support member 120 can comprise a polymeric material, such as polystyrene foam (styrofoam). In some embodiments, the support member 120 can comprise a rubber material. Other polymeric materials can also be used.

In further embodiments, the countertop 110 can include additional strengthening and/or bonding members. For example, the countertop 110 can comprise a fiberglass member. The fiberglass member can be disposed between the cement or concrete layer 118 and the support member 120.

In still further embodiments, the countertop 110 can include a coating. The coating can be disposed on one or more of the first surface 112, second surface 114, and third surface 116. The coating can provide additional or enhanced properties to the countertop 110. For example, the coating can provide increased water resistance to the countertop 110.

As previously stated, the cement or concrete layer 118 comprises a magnesium oxychloride cement composition. The cement or concrete layer 118 can further comprise one or more additional additives, including, but not limited to, aggregates or other components used to form cement or concrete structures. In some of such embodiments, the additional additives can include one or more pigments or colorants. In further of such embodiments, the additional additives can include fibers, including, but not limited to, paper fibers, polymeric fibers, organic fibers, and fiberglass. Other additional additives or mixtures thereof can also be used. In some embodiments, the additional additives can be used to make the countertop 110 look like natural stone (e.g., granite, marble, sandstone, etc.). Additional additives or mixtures thereof can also be used to aid in self leveling of the cement or concrete mixture, to reduce (or increase) air entrapment in the cement or concrete mixture, and/or to reduce (or increase) flow of the cement or concrete mixture, etc. Exemplary additives include, but are not limited to, plasticizers (polycarboxylic acid plasticizers, polycarboxylate ether-based plasticizers, etc.), microsilica, and/or fumed silica, etc.

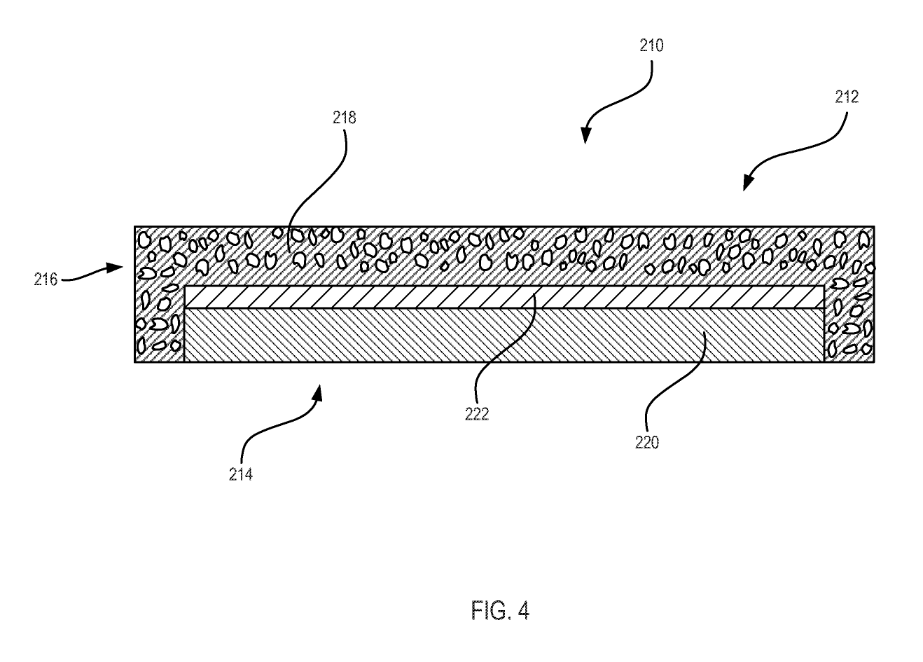

FIG. 4 is a cross-sectional view of another embodiment of a countertop 210, according to the present disclosure. As shown in FIG. 4, the countertop 210 comprises a first surface 212 (e.g., an upward facing surface), a second surface 214 (e.g., a downward facing surface), and a third surface 216 (e.g., a side surface). As further shown in FIG. 4, the countertop 210 comprises a cement or concrete layer 218 comprising a magnesium oxychloride cement composition, a support member 220, and a fiberglass member 222. The fiberglass member 222 is disposed between the cement or concrete layer 218 and the support member 220. The fiberglass member 222 can comprise a fiberglass mesh, fiberglass mat, or other fiberglass structure. The fiberglass member 222 can also provide increased strength to the countertop 210. Other intermediate members or layers can also be included.

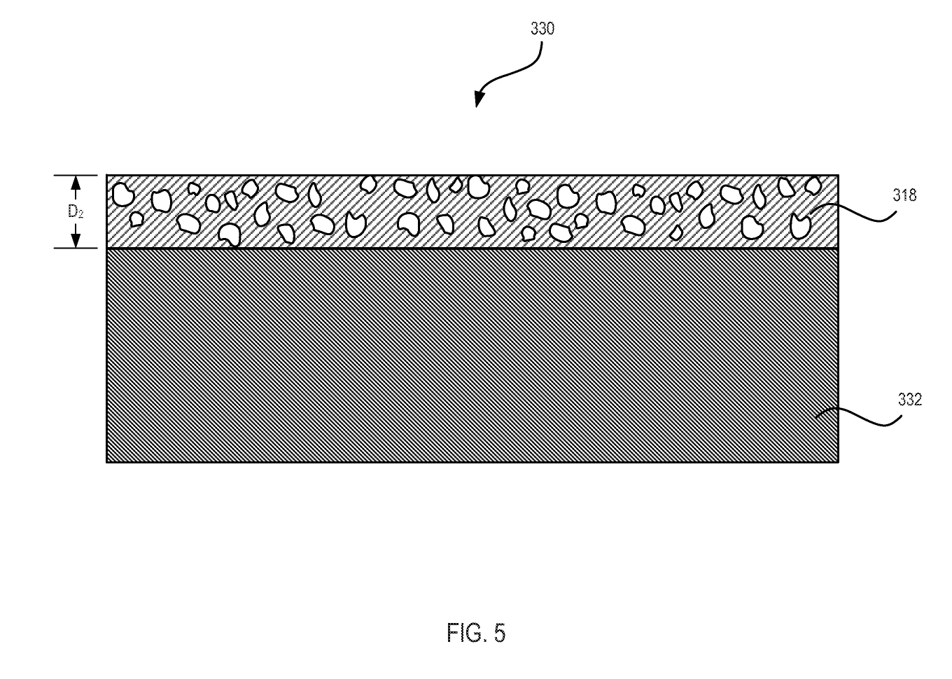

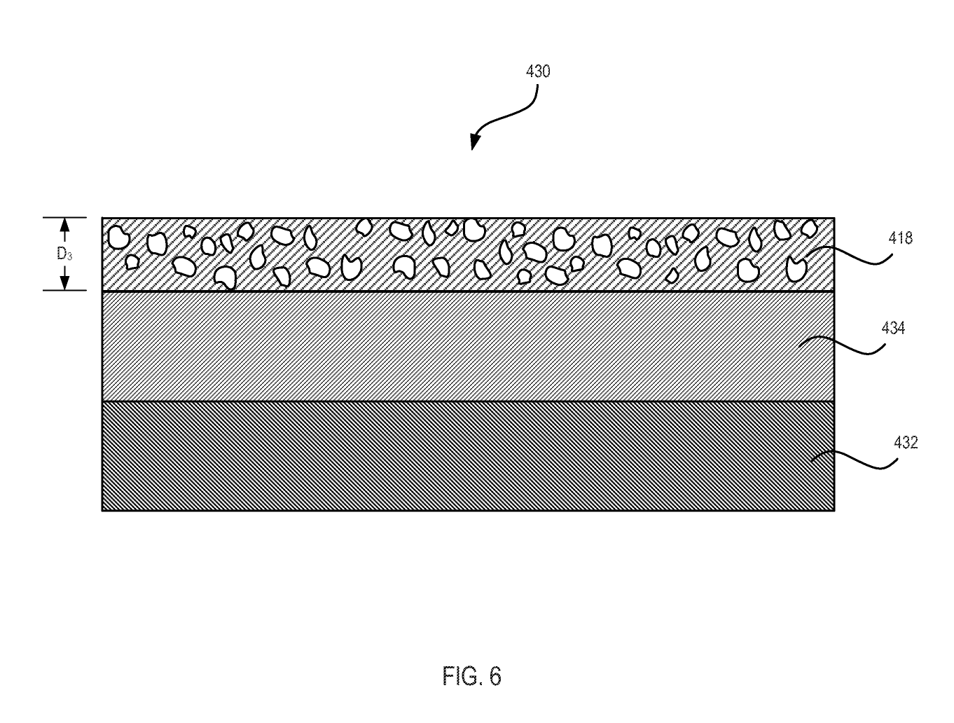

FIGS. 5-6 depict embodiments of flooring structures 330, 430, according to the present disclosure. As shown in FIGS. 5-6, in some embodiments, the flooring structure 330, 430 comprises a cement or concrete layer 318, 418. The cement or concrete layer 318, 418 comprises a magnesium oxychloride cement composition as disclosed herein. As further shown in FIGS. 5-6, the cement or concrete layer 318, 418 can be disposed on a flooring substrate 332, 432. In some embodiments, such as the embodiment of FIG. 5, the cement or concrete layer 318 can be disposed directly on top of the flooring substrate 332. In other embodiments, such as the embodiment of FIG. 6, one or more intermediate layers or materials can be disposed between the cement or concrete layer 418 and the flooring substrate 432.

With continued reference to FIGS. 5-6, the thickness of the cement or concrete layer 318, 418 of the flooring structure 330, 430 can vary. In some embodiments, the thickness D₂, D₃ of the cement or concrete layer 318, 418 can be less than 1 inch. In further embodiments, the thickness D₂, D₃ of the cement or concrete layer 318, 418 can be less than ½ inch. In some embodiments, the thickness D₂, D₃ of the cement or concrete layer 318, 418 can be about, or no greater than about, ⅜ inch. Larger thicknesses can also be used if desired. For example, thicknesses D₂, D₃ of about ½ inch, about ⅝ inch, about ⅔ inch, about ¾ inch, and greater are contemplated. Further, even greater thickness can be used in embodiments wherein the cement composition is used to form larger cement or concrete structures, e.g., such as driveways, roads, bridge structures including overlays and/or supports, etc.

With continued reference to FIGS. 5-6, any suitable variety of flooring substrate 332, 432 can be used, including, but not limited to, wood, cement, concrete, tile, etc. In some embodiments, heating elements can be disposed in the flooring structures 330, 430 to produce heated floors.

The flooring structure 330, 430 can also include additional strengthening and/or bonding members. For example, in some embodiments, the flooring structure 330, 430 comprises a fiberglass member. The fiberglass member can be disposed beneath the cement or concrete layer 318, 418. For example, in some embodiments, such as the embodiment of FIG. 5, a fiberglass member can be disposed between the cement or concrete layer 318 and the flooring substrate 332. In further embodiments, like the embodiment of FIG. 6, the fiberglass member can be disposed between the cement or concrete layer 418 and the underlay 434.

Further, in some embodiments, flooring structures 330, 430 comprising magnesium oxychloride cement compositions 318, 418 can exhibit anti-bacterial, anti-fungal, and anti-microbial properties. In such embodiments, the flooring structures 330, 430 can be advantageously used in hospitals and nursing homes.

Flooring structures 330, 430 comprising magnesium oxychloride cement compositions 318, 418 can also exhibit increased strength and wear resistance. In some of such embodiments, the flooring structures 330, 430 can be formed with seams and/or expansion joints every 30′ (ft), resulting in an approximately 30′ (ft)×30′ (ft) grid pattern. In other words, in some embodiments, the cement or concrete layer 318, 418 of the flooring structure 330, 430 can be continuous (without seams and/or expansion joints) in an area of at least approximately 30′ (ft)×30′ (ft). In further embodiments, the cement or concrete layer 318, 418 of the flooring structure 330, 430 can be continuous (without seams and/or expansion joints) in an area of at least approximately 25′ (ft)×25′ (ft). In still further embodiments, the cement or concrete layer 318, 418 of the flooring structure 330, 430 can be continuous (without seams and/or expansion joints) in an area of at least approximately 20′ (ft)×20′ (ft).

Continuous cement or concrete structures having larger areas without seams and/or expansion joints can also be made using the magnesium oxychloride cement compositions disclosed herein. For example, continuous cement or concrete structures (without seams and/or expansion joints) can be made having areas of at least approximately 50′ (ft)×50′ (ft), at least approximately 75′ (ft)×75′ (ft), and at least approximately 100′ (ft)×100′ (ft), or even greater.

As previously stated, the cement or concrete layer 318, 418 of the flooring structure 330, 430 comprises a magnesium oxychloride cement composition. In still further embodiments, the magnesium oxychloride cement composition 318, 418 can include one or more additional additives, including, but not limited to, aggregates or other components used to form cement or concrete structures. In some of such embodiments, the additional additives can include one or more pigments or colorants. In further of such embodiments, the additional additives can include fibers, including, but not limited to, paper fibers, polymeric fibers, organic fibers, and fiberglass. Other additional additives or mixtures thereof can also be used. In some embodiments, the additional additives can be used to make the flooring structure 330, 430 look like natural stone (e.g., granite, marble, sandstone, etc.). Additional additives or mixtures thereof can also be used to aid in self leveling of the cement or concrete mixture, to reduce (or increase) air entrapment in the cement or concrete mixture, and/or to reduce (or increase) flow of the cement or concrete mixture, etc. Exemplary additives include, but are not limited to, plasticizers (polycarboxylic acid plasticizers, polycarboxylate ether-based plasticizers, etc.), microsilica, and/or fumed silica, etc.

With reference to FIG. 6, in some embodiments, the flooring structure 430 comprises a cement or concrete layer 418 and an underlay 434. As shown in FIG. 6, the cement or concrete layer 418 and the underlay 434 are disposed on a flooring substrate 432. As further shown in FIG. 6, the underlay 434 is disposed between the cement or concrete layer 418 and the flooring substrate 432.

Various types of underlays can be used. For example, in some embodiments, the underlay 434 comprises a cushioning member. In such embodiments, the underlay 434 can comprise a foam material. In other such embodiments, the underlay 434 can comprise a sponge-like material. In yet other such embodiments, the underlay 434 can comprise a rubber material. In further such embodiments, the underlay 434 can comprise a polymeric material. Other cushioning members can also be used, including natural materials, synthetic materials, or mixtures thereof. In further embodiments, the underlay 434 can comprise carpet. For example, a cement or concrete layer 418 can be disposed on a carpet that is already disposed on a flooring substrate 432.

The underlay 434 can increase the softness and flexibility of the flooring structure 430. For example, forces can be exerted on the flooring structure 430, for example, by walking across the flooring structure 430. The underlay 434 can compress in response to the forces, which can allow the cement or concrete layer 418 to flex and/or bend (without cracking or breaking) in response to the forces being exerted upon it. The flexibility can also be reversible. For example, the underlay 434 and the cement or concrete layer 418 can substantially return to their normal conformation after the forces have been removed. As can be appreciated, the increased softness and flexibility of the flooring structure 430 can cause less stress and tension to the joints and legs of people walking across the flooring structure 430. The increased flexibility of the flooring structure 430 can also minimize or eliminate cracks or breaks from forming in the cement or concrete layer 418.

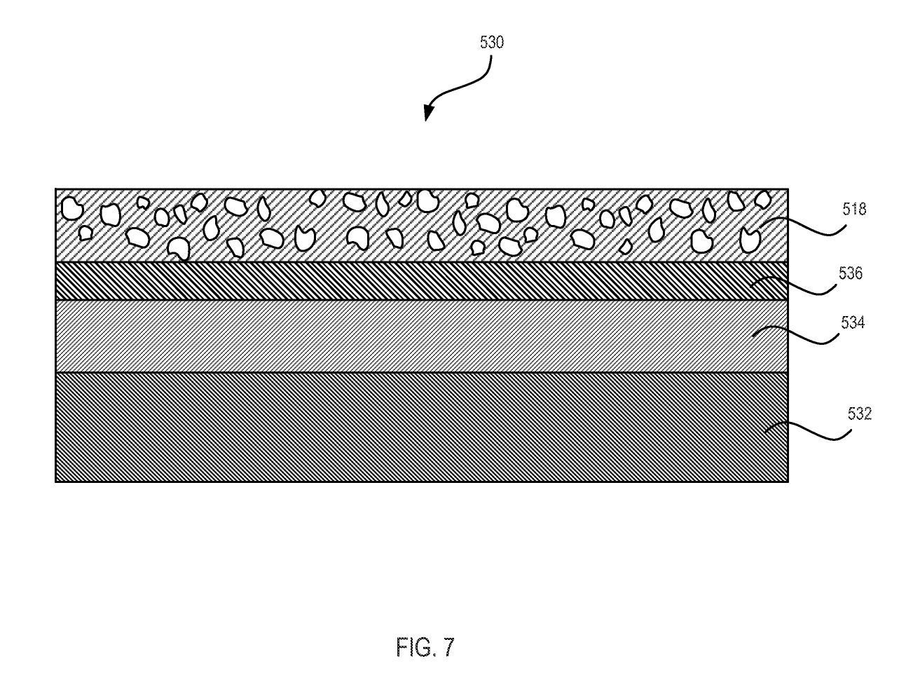

FIG. 7 is a cross-sectional view of another embodiment of a flooring structure 530, according to the present disclosure. As shown in FIG. 7, the flooring structure 530 comprises a cement or concrete layer 518 comprising a magnesium oxychloride cement composition, an underlay 534, a flooring substrate 532, and a fiberglass member 536. The fiberglass member 536 is disposed between the cement or concrete layer 518 and the underlay 534. The fiberglass member 536 can comprise a fiberglass mesh, fiberglass mat, or other fiberglass structure. The fiberglass member 536 can also provide increased strength to the flooring structure 530. Other intermediate layers can also be included.

As previously mentioned, it will be appreciated that the magnesium oxychloride cement compositions can also be used to make other cement or concrete structures, including, but not limited to, tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, and other cement or concrete structures. Further, it will be appreciated that the structures can be any variety of shapes and/or sizes, and can be used for any variety of purposes. These structures can be, in many ways, analogous to the countertops 110, 210 and flooring structures 330, 430, 530 discussed above with reference to FIGS. 1-7. For example, the structures (e.g., tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, etc.) can include a support member. However, if desired, a support member need not be used. In some embodiments, the support member can comprise a polymeric material (e.g., rubber material). Further, in some embodiments, the support member can be referred to as a backing or backing member. In other embodiments, a support member is not used.

Analogous to the countertops 110, 210 discussed above, the structures (e.g., tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, etc.) can also include one or more of additional strengthening and/or bonding members (e.g., fiberglass members), coatings, and additional additives (e.g., aggregates, pigments, colorants, fibers, etc.).

The thickness of the cement or concrete layer in these other structures (e.g., tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, etc.) can also vary. For example, in some embodiments, the thickness of the cement or concrete layer of certain of these structures (e.g., tile structures, panel structures, etc.) can be less than ½ inch. In further embodiments, the thickness of the cement or concrete layer of certain of these structures (e.g., tile structures, panel structures, etc.) can be less than ¼ inch. In yet further embodiments, the thickness of the cement or concrete layer of certain of these structures (e.g., tile structures, panel structures, etc.) can be about, or no greater than about, 3/16 inch. In yet further embodiments, the thickness of the cement or concrete layer of certain of these structures (e.g., tile structures, panel structures, etc.) can be between about 3/16 inch and about ¼ inch, or between about ⅛ inch and about ¼ inch. Greater thickness are also contemplated as desired. For example, the thickness of the cement or concrete layer of other structures (e.g., driveways, roads (e.g., highways, etc.), bridge structures including overlays and/or supports, etc.) can be greater depending on the particular application.

As can be appreciated, certain structures (e.g., tile structures, panel structures, etc.) can be used in many ways. In some embodiments, the structures (e.g., tile structures, panel structures, etc.) can be used to form flooring structures, wall structures, and/or roof structures. For example, the structures (e.g., tile structures, panel structures, etc.) can be used to form the floor and/or wall of a shower (e.g., shower wall panels, etc.). Other flooring, wall, and/or roofing applications are also contemplated.

Additionally, in some embodiments, the structures (e.g., tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, etc.) can be used with an underlay, analogous to the underlay 434, 534 disclosed above with reference to FIGS. 5-7. For example, in some applications, the structures (e.g., tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, etc.) can be disposed above (or adjacent to) a cushioned underlay. The structures (e.g., tile structures (e.g., floor tiles, roof tiles, etc.), panel structures (e.g., floor panels, shower panels, wall panels, etc.), fencing structures including panels and/or supports, driveways, roads (e.g., highways, etc.), bridge structures including overlays and/or supports, etc.) can also exhibit anti-bacterial, anti-fungal, and anti-microbial properties, analogous to the flooring structures disclosed above with reference to FIGS. 5-7. Analogously, the countertops 110, 210 discussed above with reference to FIGS. 1-4 can also exhibit anti-bacterial, anti-fungal, and anti-microbial properties.

The embodiments disclosed herein further include methods of using the disclosed magnesium oxychloride cement compositions. For example, in some embodiments, methods of forming countertops (or other cement or concrete structures, including, but not limited to tile structures, panel structures, etc.) are disclosed. In such embodiments, the method can include a step of arranging a mold apparatus on a designated surface, wherein the mold defines the shape and/or size of the countertop (or other cement or concrete structure, including, but not limited to, tile structures, panel structures, etc.). In some embodiments, the method can further include a step of applying a release agent onto the surface. Various release agents can be used, including, but not limited to, silicone based release agents. In some embodiments, the silicone based release agent comprises methanol cure silicone, silicone oils, silicone fume, sulfuric acid, water, and/or mixtures thereof.

In some embodiments, the method can further include a step of pouring (or reverse pouring) and forming a magnesium oxychloride cement composition (or a concrete mixture comprising a magnesium oxychloride cement composition) into the mold. In some embodiments, the method can further include a step of disposing a fiberglass member (e.g., fiberglass mesh) into the cement or concrete composition. In some embodiments, the method can further include a step of disposing or embedding the support member into the cement or concrete composition. In some embodiments, the method can further include a step of allowing the cement or concrete composition to dry and/or cure. In some embodiments, the method can further include a step of removing the countertop (or other cement or concrete structure, including, but not limited to, tile structures, panel structures, etc.) from the mold and applying a coating onto a surface of the countertop (or other cement or concrete structure).

In further embodiments, methods of forming flooring structures are disclosed. In such embodiments, the method can include a step of disposing an underlay onto a flooring substrate. In some embodiments, the method can further include a step of disposing a fiberglass member (e.g., fiberglass mesh) onto the underlay (or onto the flooring substrate if no underlay is being used). In some embodiments, the method can further include a step of pouring and forming a magnesium oxychloride cement composition (or a concrete mixture comprising a magnesium oxychloride cement composition). In some embodiments, the method can further include a step of allowing the cement or concrete composition to dry and/or cure.

As will be appreciated, any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

The following examples are illustrative of certain embodiments disclosed herein and are not intended to be limiting in any way.

### Example 1

A magnesium oxychloride cement composition was made by mixing about 6.5 lbs of magnesium oxide powder, about 9 lbs of aqueous magnesium chloride (MgCl₂ (aq)) (31° Baume), and about 18 fluid ounces of silicone oil (100 cSt (25° C.)). The magnesium oxychloride cement composition also included about 5 ml of a surfactant (TERGITOL). About 25 lbs of calcium carbonate sand and about 0.5 lb of paper fibers were added to the magnesium oxychloride cement composition to form a concrete mixture.

A fiberglass mesh scrim was placed in a mold apparatus, and the concrete mixture was poured into the mold apparatus to form a 6′ (ft) long×12″ (inch) wide×¼″ (inch) thick concrete structure. After curing, the concrete structure was removed and its flexibility was tested. It was determined that the structure was able to bend at least 6″ (inches) at its midsection without cracking and/or breaking.

### Example 2

A magnesium oxychloride cement composition was made by mixing about 6.5 lbs of magnesium oxide powder, about 9 lbs of aqueous magnesium chloride (MgCl₂ (aq)) (28° Baume), about 16 fluid ounces of silanol fluid (15,000 cSt (25° C.)), and about 2 fluid ounces of methyltris(methylethylketoximino)silane. The magnesium oxychloride cement composition also included about 25 ml of a surfactant (TERGITOL). About 35 lbs of calcium carbonate sand was added to the magnesium oxychloride cement composition to form a concrete mixture.

The concrete mixture was poured and formed into 9 two-inch cubes (Samples 1A-9A), which were set to cure for 7 days. After curing, the compression strength of three cubes (Samples 1A-3A) was measured. The remaining six cubes (Samples 4A-9A) were submerged in distilled water for about 24 hours.

After about 24 hours of being submerged, the six cubes (Samples 4A-9A) were removed from the distilled water and the compression strength of two cubes (Samples 4A-5A) was measured. The remaining four cubes (Samples 6A-9A) were left to dry at ambient conditions for about 48 hours. The four remaining cubes (Samples 6A-9A) were then submerged in fresh distilled water for about an additional 24 hours.

After about 24 hours of being submerged, the four cubes (Samples 6A-9A) were removed from the distilled water and the compression strength of two cubes (Samples 6A-7A) was measured. The remaining two cubes (Samples 8A-9A) were left to dry at ambient conditions for about 48 hours. The two remaining cubes (Samples 8A-9A) were then submerged in fresh distilled water for about an additional 24 hours.

After about 24 hours of being submerged, the two cubes (Samples 8A-9A) were removed from the distilled water and their compression strength was measured.

The average compression strengths (in psi) of the nine cubes (Samples 1A-9A) are set forth below in Table I:

TABLE I

| Sample No. | Average Compressive Strength (PSI) |
|---|---|
| Samples 1A-3A | 4200-4300 |
| Samples 4A-5A | 4000-4100 |
| Samples 6A-7A | 4100-4200 |
| Samples 8A-9A | 4100-4200 |

As shown in Table I, the cubes retained a relatively high compressive strength, even after being subjected to multiple wet (submerged) and dry cycles.

### Example 3

A magnesium oxychloride cement composition was made by mixing about 6.5 lbs of magnesium oxide powder, about 9 lbs of aqueous magnesium chloride (MgCl₂ (aq)) (28° Baume), 16 fluid ounces of silanol fluid (15,000 cSt (25° C.)), and 2 fluid ounces of methyltriethoxysilane. The magnesium oxychloride cement composition also included about 25 ml of a surfactant (TERGITOL). About 35 lbs of calcium carbonate sand was added to the magnesium oxychloride cement composition to form a concrete mixture.

The concrete mixture was poured and formed into 9 two-inch cubes (Samples 1B-9B), which were set to cure for 7 days. After curing, the compression strength of three cubes (Samples 1B-3B) was measured. The remaining six cubes (Samples 4B-9B) were submerged in distilled water for about 24 hours.

After about 24 hours of being submerged, the six cubes (Samples 4B-9B) were removed from the distilled water and the compression strength of two cubes (Samples 4B-5B) was measured. The remaining four cubes (Samples 6B-9B) were left to dry at ambient conditions for about 48 hours. The four remaining cubes (Samples 6B-9B) were then submerged in fresh distilled water for about an additional 24 hours.

After about 24 hours of being submerged, the four cubes (Samples 6B-9B) were removed from the distilled water and the compression strength of two cubes (Samples 6B-7B) was measured. The remaining two cubes (Samples 8B-9B) were left to dry at ambient conditions for about 48 hours. The two remaining cubes (Samples 8B-9B) were then submerged in fresh distilled water for about an additional 24 hours.

After about 24 hours of being submerged, the two cubes (Samples 8B-9B) were removed from the distilled water and their compression strength was measured.

The average compression strengths (in psi) of the nine cubes (Samples 1B-9B) are set forth below in Table II:

TABLE II

| Sample No. | Average Compressive Strength (PSI) |
|---|---|
| Samples 1B-3B | 3900-4000 |
| Samples 4B-5B | 3700-3800 |
| Samples 6B-7B | 3700-3800 |
| Samples 8B-9B | 3900-4000 |

As shown in Table II, the cubes retained a relatively high compressive strength, even after being subjected to multiple wet (submerged) and dry cycles.

### Example 4

A magnesium oxychloride cement composition was made by mixing about 6.5 lbs of magnesium oxide powder, about 9 lbs of aqueous magnesium chloride (MgCl₂ (aq)) (28° Baume), and about 18 fluid ounces of silanol fluid (15,000 cSt (25° C.)). The magnesium oxychloride cement composition also included about 25 ml of a surfactant (TERGITOL). About 35 lbs of calcium carbonate sand was added to the magnesium oxychloride cement composition to form a concrete mixture.

The concrete mixture was poured and formed into 9 two-inch cubes (Samples 1C-9C), which were set to cure for 7 days. After curing, the compression strength of three cubes (Samples 1C-3C) was measured. The remaining six cubes (Samples 4C-9C) were submerged in distilled water for about 24 hours.

After about 24 hours of being submerged, the six cubes (Samples 4C-9C) were removed from the distilled water and the compression strength of two cubes (Samples 4C-5C) was measured. The remaining four cubes (Samples 6C-9C) were left to dry at ambient conditions for about 48 hours. The four remaining cubes (Samples 6C-9C) were then submerged in fresh distilled water for about an additional 24 hours.

After about 24 hours of being submerged, the four cubes (Samples 6C-9C) were removed from the distilled water and the compression strength of two cubes (Samples 6C-7C) was measured. The remaining two cubes (Samples 8C-9C) were left to dry at ambient conditions for about 48 hours. The two remaining cubes (Samples 8C-9C) were then submerged in fresh distilled water for about an additional 24 hours.

After about 24 hours of being submerged, the two cubes (Samples 8C-9C) were removed from the distilled water and their compression strength was measured.

The average compression strengths (in psi) of the nine cubes (Samples 1C-9C) are set forth below in Table III:

TABLE III

| Sample No. | Average Compressive Strength (PSI) |
|---|---|
| Samples 1C-3C | 5000-5100 |
| Samples 4C-5C | 4500-4600 |
| Samples 6C-7C | 4300-4400 |
| Samples 8C-9C | 4000-4100 |

As shown in Table III, the cubes retained a relatively high compressive strength, even after being subjected to multiple wet (submerged) and dry cycles.

### Example 5

A comparison magnesium oxychloride cement composition was made by mixing about 6.5 lbs of magnesium oxide powder and about 9 lbs of aqueous magnesium chloride (MgCl₂ (aq)) (28° Baume). No silicone based additives were added to the mixture. About 35 lbs of calcium carbonate sand was added to the magnesium oxychloride cement composition to form a concrete mixture.

A fiberglass mesh scrim was placed in a mold apparatus, and the concrete mixture was poured into the mold apparatus to form a 8″ (inch) wide×12″ (inch) long×¼″ (inch) thick concrete structure. The concrete structure was set to cure for 3 days, and tested as follows:

After curing, the concrete structure was submerged in water for about 24 hours. After about 24 hours of being submerged, the concrete structure was removed from the water and left to dry for about 24 hours at ambient conditions.

The concrete structure was then submerged in water for about an additional 24 hours. After about 24 hours of being submerged, the concrete structure was removed from the water. Following removal of the concrete structure from the water, the concrete structure crumbled and broke into several pieces.

### Example 6

A magnesium oxychloride cement composition was made by mixing about 6.5 lbs of magnesium oxide powder, about 9 lbs of aqueous magnesium chloride (MgCl₂ (aq)) (28° Baume), and about 18 fluid ounces of silanol fluid (15,000 cSt (25° C.)). The magnesium oxychloride cement composition also included about 200 grams of fumed silica (200 m²/g), about 60 grams of plasticizer (polycarboxylate ether (PCE)), and a standard brown paint pigment. About 35 lbs of calcium carbonate sand was added to the magnesium oxychloride cement composition to form a concrete mixture.

A fiberglass mesh scrim was placed in a mold apparatus, and the concrete mixture was poured into the mold apparatus to form a concrete structure that was cured for about 10 days and cut into 6″ (inch)×6″ (inch) square samples having a thickness of about ⅜″ (inch). The concrete samples were then tested as follows:

After curing, the compressive strength of one sample was measured and determined to be about 5,000 psi. The remaining samples were submerged in water for about 24 hours. After about 24 hours of being submerged, the samples were removed from the water and the compression strength of a sample was measured and determined to be approximately 4,200 psi. The remaining samples were then left to dry for about 24 hours at ambient conditions. The remaining samples were then submerged in water for about an additional 24 hours.

After about 24 hours of being submerged, the samples were removed from the water and the compression strength of a sample was measured and determined to be approximately 3,800 psi. The remaining samples were then left to dry for about 24 hours at ambient conditions. The remaining samples were then submerged in water for about an additional 24 hours.

After about 24 hours of being submerged, the samples were removed from the water and the compression strength of one sample was measured and determined to be approximately 3,800 psi. The remaining sample was then left to dry for about 24 hours at ambient conditions. The remaining sample was then subjected to an additional 11 cycles of being submerged in water for about 24 hours and dried for about 24. After the final submersion cycle, the compression strength of the sample was measured and determined to be about 3,800 psi.

Thus, after an initial decrease in compressive strength, the samples largely retained their compressive strength, even after being subjected to multiple wet (submerged) and dry cycles.

### Example 7

A magnesium oxychloride cement composition was made by mixing about 6.5 lbs of magnesium oxide powder, about 9 lbs of aqueous magnesium chloride (MgCl₂ (aq)) (28° Baume), about 16 fluid ounces of silanol fluid (15,000 cSt (25° C.)), and about 2 fluid ounces of methyltris(methylethylketoximino)silane. The magnesium oxychloride cement composition also included about 200 grams of fumed silica (200 m²/g), about 60 grams of plasticizer (polycarboxylate ether (PCE)), and a standard brown paint pigment. About 35 lbs of calcium carbonate sand was added to the magnesium oxychloride cement composition to form a concrete mixture.

The concrete mixture was then poured over an existing concrete patio to form a seamless concrete layer that was about 16′ (ft) long×about 8′ (ft) wide, having a thickness of about ⅜″ (inch). The concrete layer was cured for about 24 hours and coated with a standard acrylic concrete coating.

The concrete layer was then continuously exposed to water for a period of about 4 months. After being continuously exposed to water for about 4 months, there was no noticeable loss of coloration and/or color fading. The concrete layer also did not exhibit any noticeable degradation or appearance of breakdown.

References to approximations are made throughout this specification, such as by use of one or more of the terms “about,” “approximately,” “substantially,” and “generally.” For each such reference, it is to be understood that, in some embodiments, the value, feature, or characteristic may be specified without approximation. For example, where such a qualifier is used, the term includes within its scope the qualified word in the absence of the qualifier.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment. Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any embodiment requires every feature shown in a particular drawing.

Unless otherwise noted, the terms “a” or “an” are to be construed as meaning “at least one of.” In addition, for ease of use, the words “including” and “having” are interchangeable with and have the same meaning as the word “comprising.” Recitation of the term “first” with respect to a feature or element does not necessarily imply the existence of a second or additional such feature or element.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

1. A magnesium oxychloride cement composition comprising:
magnesium oxide;
aqueous magnesium chloride, wherein the specific gravity of the aqueous magnesium chloride is between about 17° Baume and about 37° Baume; and
a silicone based additive;
wherein the ratio of magnesium oxide to aqueous magnesium chloride is between about 0.4:1 and about 1.2:1, by weight; and
wherein the ratio between the silicone based additive to magnesium oxide is between about 1 fl oz:1 lb and about 8 fl oz:1 lb.

2. The magnesium oxychloride cement composition of claim 1,
wherein the magnesium oxychloride cement composition is formed into a structure having a thickness of less than 1 inch.

3. The magnesium oxychloride cement composition of claim 1, wherein the magnesium oxychloride cement composition is formed into a structure having a thickness of less than ½ inch.

4. The magnesium oxychloride cement composition of claim 1, wherein the silicone based additive comprises at least one of silicone oil, silanol fluid, or hydroxyl terminated siloxane.

5. The magnesium oxychloride cement composition of claim 1, wherein the silicone based additive has a viscosity of between about 1000 sCt (25° C.) and about 80,000 sCt (25° C.).

6. The magnesium oxychloride cement composition of claim 1, wherein the silicone based additive comprises a mixture of silanol fluid and a crosslinker.

7. The magnesium oxychloride cement composition of claim 6, wherein the ratio of silanol fluid to crosslinker is between about 1:20 and about 20:1, by weight.

8. The magnesium oxychloride cement composition of claim 1, wherein the magnesium oxychloride cement composition cures to form greater than 90% 5Mg(OH)₂.MgCl₂.8H₂O (phase 5) crystalline structures.

9. The magnesium oxychloride cement composition of claim 1, wherein the magnesium oxychloride cement composition comprises water resistant properties.

10-19. (canceled)

20. A flooring structure, comprising:
a concrete layer disposed on a flooring substrate, wherein the concrete layer comprises a magnesium oxychloride cement composition, the magnesium oxychloride cement composition comprising:
magnesium oxide;
aqueous magnesium chloride; and
a silicone based additive.

21. The flooring structure of claim 20, wherein the concrete layer has a thickness of less than 1 inch.

22. (canceled)

23. The flooring structure of claim 20, further comprising:
an underlay, wherein the underlay is disposed at a location that is between the concrete layer and the flooring substrate.

24. The flooring structure of claim 23, wherein the underlay comprises a cushioned underlay.

25. The flooring structure of claim 24, wherein the underlay comprises a foam material.

26. The flooring structure of claim 20, wherein the concrete layer is continuous for a length of at least 100′ (ft)×100′ (ft).

27. The flooring structure of claim 20, wherein the specific gravity of the aqueous magnesium chloride is between about 17° Baume and about 37° Baume;
wherein the ratio of magnesium oxide to aqueous magnesium chloride is between about 0.4:1 and about 1.2:1, by weight; and
wherein the ratio between the silicone based additive to magnesium oxide is between about 1 fl oz:1 lb and about 8 fl oz:1 lb.

28. (canceled)

29. The flooring structure of claim 20, wherein the silicone based additive comprises at least one of silicone oil, silanol fluid, or hydroxyl terminated siloxane.

30. The flooring structure of claim 20, wherein the silicone based additive has a viscosity between about 1000 sCt (25° C.) and about 80,000 sCt (25° C.).

31-35. (canceled)

36. A method of manufacturing a concrete structure; comprising:
arranging a mold apparatus on a surface, wherein the mold apparatus defines the shape of the concrete structure;
pouring a concrete mixture comprising a magnesium oxychloride cement composition into the mold apparatus, wherein the magnesium oxychloride cement composition comprises magnesium oxide, aqueous magnesium chloride, and a silicone based additive; and
disposing a support member into the concrete mixture.

37. The method of claim 36, wherein the concrete structure comprises a tile or panel.

38-48. (canceled)
